(19) United States
(12) Patent Application Publication
(10) Pub. No.: US 2025/0218172 A1
(43) Pub. Date: Jul. 3, 2025

(54) APPARATUS AND METHOD FOR CONTROLLING A VEHICLE

(71) Applicants: HYUNDAI MOTOR COMPANY, Seoul (KR); KIA CORPORATION, Seoul (KR)

(72) Inventors: Jong Hyun Choi, Hwaseong-si (KR); Jun Sik An, Hwaseong-si (KR)

(73) Assignees: HYUNDAI MOTOR COMPANY, Seoul (KR); KIA CORPORATION, Seoul (KR)

(21) Appl. No.: 18/954,007

(22) Filed: Nov. 20, 2024

(30) Foreign Application Priority Data
Jan. 2, 2024 (KR) 10-2024-0000337

(51) Int. Cl. G06V 10/98; G06T 7/50; G06T 7/70; G06T 7/90; G06T 17/20; G06V 10/762; G06V 20/58

(52) U.S. Cl. CPC G06V 10/98; G06T 7/50; G06T 7/70; G06T 7/90; G06T 17/20; G06V 10/762; G06V 20/58; G06T 2207/10024; G06T 2207/30261

(57) ABSTRACT

A vehicle control apparatus may include cameras and a processor. The processor may: obtain, based on first images obtained through the cameras, depth information indicating a distance between a vehicle and an external object and semantic information including data associated with a type of the external object; generate sets of first space tensors corresponding to the first images representing at least a portion within a specified radius from the vehicle; convert the sets of first space tensors to sets of second space tensors represented in a reference coordinate system; identify an object space tensor regarding a first specified type in the sets of second space tensors based on identifying a reference image; generate sets of third space tensors by correcting the sets of second space tensors based on a set of reference space tensors included in the reference image; and output modeling information representing the first images in 3D space.

### CROSS-REFERENCE TO RELATED APPLICATION

This application claims the benefit of and priority to Korean Patent Application No. 10-2024-0000337, filed on Jan. 2, 2024, the entire contents of which are hereby incorporated herein by reference.

### TECHNICAL FIELD

The present disclosure relates to a vehicle control apparatus and a method thereof, and more particularly, relates to a technology for correcting images.

### BACKGROUND

Various studies are being conducted to identify an external object by using various sensors to assist the driving of a vehicle.

While the vehicle is driving in a driving assistance device activation mode or an autonomous driving mode, surrounding environments of the vehicle may be expressed by using various sensors (e.g., a light detection and ranging (LiDAR), a camera, a radio detection and ranging (RADAR), etc.).

If surrounding environments of the vehicle may be expressed by using a camera, images may be distorted when using images obtained by a plurality of cameras. For example, because delicate manipulation is used while a vehicle is parking, the desire to reduce image distortion is being discussed.

### SUMMARY

The present disclosure was made to solve the above-mentioned problems occurring in the prior art while advantages achieved by the prior art are maintained intact.

Aspects of the present disclosure provide a vehicle control apparatus and a method that may accurately project and provide a surrounding environment of a vehicle in three-dimensional (3D) space.

Aspects of the present disclosure provide a vehicle control apparatus and a method that may improve stability in parking situations by accurately identifying and providing a distance between the vehicle and an external object.

Aspects of the present disclosure provide a vehicle control apparatus and a method that may enhance user experience by accurately providing a user with the surrounding environment of the vehicle.

The technical problems to be solved by the present disclosure are not limited to the aforementioned problems. Other technical problems not mentioned herein should be more clearly understood from the following description by those having ordinary skill in the art to which the present disclosure pertains.

According to an aspect of the present disclosure, a vehicle control apparatus is provided. The vehicle control apparatus may include a plurality of cameras and a processor. The processor may be configured to, based on first images obtained through the plurality of cameras, obtain i) depth information indicating a distance between a vehicle and an external object included in each of the first images and ii) semantic information including data associated with a type of the external object. The processor may also be configured to generate sets of first space tensors respectively corresponding to the first images representing at least a portion within a specified radius from the vehicle based on at least one of the depth information, the semantic information, or any combination thereof, that is included in each of the first images. The processor may further be configured to convert the sets of first space tensors to sets of second space tensors represented in a reference coordinate system including a first axis, a second axis, and a third axis. The processor may additionally be configured to identify at least one object space tensor regarding a first specified type indicating a specified external object in each of the sets of second space tensors based on identifying a reference image according to a specified condition among the first images. The processor may also be configured to generate sets of third space tensors by correcting the sets of second space tensors based on a set of reference space tensors included in the reference image, based on identifying a space tensor corresponding to the object space tensor in each of the sets of second space tensors. The processor may additionally be configured to output modeling information representing the first images in 3D space, based on applying a specified algorithm to the set of reference space tensors and the sets of third space tensors.

In an embodiment, the processor may be configured to obtain second images including the first images through the plurality of cameras at a plurality of time points including a time point at which the first images are obtained. The processor may also be configured to generate the sets of first space tensors in each of the second images.

In an embodiment, the processor may be configured to correct the sets of second space tensors based on a camera placed toward a front of the vehicle among the plurality of cameras.

In an embodiment, the processor may be configured to remove a background space tensor from each of the sets of second space tensors based on identifying at least one background space tensor regarding a second specified type, that is different from the first specified type and that indicates a background, in each of the sets of second space tensors.

In an embodiment, the processor may be configured to perform clustering on the sets of second space tensors included in a specified duration based on performing voxelization on the sets of second space tensors.

In an embodiment, the processor may be configured to convert the sets of first space tensors into the sets of second space tensors based on at least one of the sets of first space tensors, internal parameters associated with the plurality of cameras, or any combination thereof.

In an embodiment, the processor may be configured to calculate a mean space tensor change amount based on i) a first portion of the sets of second space tensors identified at a first time point and ii) a second portion of the sets of second space tensors identified at a second time point. The processor may also be configured to represent the modeling information by projecting a stationary object onto the reference coordinate system based on the mean space tensor change amount. The mean space tensor change amount may include a change amount of a value representing a color of the second portion corresponding to the first portion.

In an embodiment, the processor may be configured to project the stationary object onto the reference coordinate system based on the mean space tensor change amount and a stationary object detection algorithm.

In an embodiment, the stationary object detection algorithm may include at least one of a region of interest (ROI)-based algorithm, a difference frame algorithm, an optical flow-based algorithm, a histogram-based algorithm, an algorithm using a motion sensor, or any combination thereof.

In an embodiment, the vehicle control apparatus may further include at least one of a Light Detection and Ranging (LiDAR), a RADAR, or any combination thereof. The processor may be configured to identify a distance between the external object and the vehicle based on at least one of the LiDAR, the RADAR, or any combination thereof. The processor may also be configured to apply the distance between the external object and the vehicle to at least one of the sets of first space tensors, the sets of second space tensors, the sets of third space tensors, or any combination thereof.

In an embodiment, the specified algorithm may include a mesh generation algorithm. The mesh generation algorithm may include at least one of a ball rolling algorithm, a Delaunay triangulation, a marching cubes algorithm, a Voronoi diagram, a geometry-based mesh generation algorithm, a polygon mesh generation algorithm, or any combination thereof.

According to another aspect of the present disclosure, a vehicle control method is provided. The vehicle control method may include obtaining i) depth information indicating a distance between a vehicle and an external object included in each of first images obtained through a plurality of cameras and ii) semantic information including data associated with a type of the external object. The vehicle control method may also include generating sets of first space tensors respectively corresponding to the first images representing at least a portion within a specified radius from the vehicle based on at least one of the depth information, the semantic information, or any combination thereof, that is included in each of the first images. The vehicle control method may further include converting the sets of first space tensors to sets of second space tensors represented in a reference coordinate system including a first axis, a second axis, and a third axis. The vehicle control method may also include identifying at least one object space tensor regarding a first specified type indicating a specified external object in each of the sets of second space tensors based on identifying a reference image according to a specified condition among the first images. The vehicle control method may additionally include generating sets of third space tensors by correcting the sets of second space tensors based on a set of reference space tensors included in the reference image, based on identifying a space tensor corresponding to the object space tensor in each of the sets of second space tensors. The vehicle control method may further include outputting modeling information representing the first images in 3D space, based on applying a specified algorithm to the set of reference space tensors and the sets of third space tensors.

The vehicle control method according to an embodiment may further include obtaining second images including the first images through the plurality of cameras at a plurality of time points including a time point at which the first images are obtained. The vehicle control method may also include generating the sets of first space tensors in each of the second images.

The vehicle control method according to an embodiment may further include correcting the sets of second space tensors based on a camera placed toward a front of the vehicle among the plurality of cameras.

The vehicle control method according to an embodiment may further include removing a background space tensor from each of the sets of second space tensors based on identifying the at least one background space tensor regarding a second specified type, which is different from the first specified type and which indicates a background, in each of the sets of second space tensors.

The vehicle control method according to an embodiment may further include performing clustering on the sets of second space tensors included in a specified duration based on performing voxelization on the sets of second space tensors.

The vehicle control method according to an embodiment may further include converting the sets of first space tensors into the sets of second space tensors based on at least one of the sets of first space tensors, internal parameters associated with the plurality of cameras, or any combination thereof.

The vehicle control method according to an embodiment may further include calculating a mean space tensor change amount based on i) a first portion of the sets of second space tensors identified at a first time point and ii) a second portion of the sets of second space tensors identified at a second time point. The vehicle control method may also include representing the modeling information by projecting a stationary object onto the reference coordinate system based on the mean space tensor change amount. The mean space tensor change amount may include a change amount of a value representing a color of the second portion corresponding to the first portion.

The vehicle control method according to an embodiment may further include projecting the stationary object onto the reference coordinate system based on the mean space tensor change amount and a stationary object detection algorithm.

In an embodiment, the stationary object detection algorithm may include at least one of a region of interest (ROI)-based algorithm, a difference frame algorithm, an optical flow-based algorithm, a histogram-based algorithm, an algorithm using a motion sensor, or any combination thereof.

### BRIEF DESCRIPTION OF THE DRAWINGS

The above and other objects, features, and advantages of the present disclosure should be more apparent from the following detailed description taken in conjunction with the accompanying drawings, in which:

FIG. 1 shows a block diagram of a vehicle control apparatus, according to an embodiment of the present disclosure;

FIG. 2 shows an example of obtaining depth information and semantic information based on an image, in an embodiment of the present disclosure;

FIG. 3 shows an example of correcting an image or space tensor, in an embodiment of the present disclosure;

FIG. 4 shows an example of accumulating and integrating space tensors, in an embodiment of the present disclosure;

FIG. 5 shows an example of generating modeling information, in an embodiment of the present disclosure;

FIG. 6 shows a flowchart associated with a vehicle control method, according to an embodiment of the present disclosure;

FIG. 7 shows a flowchart associated with a vehicle control method, according to an embodiment of the present disclosure; and

FIG. 8 shows a computing system associated with a vehicle control apparatus or vehicle control method, according to an embodiment of the present disclosure.

### DETAILED DESCRIPTION

Hereinafter, embodiments of the present disclosure are described in detail with reference to the accompanying drawings. In adding reference numerals to components of the drawings, it should be noted that the same or equivalent components are designated by the same reference numerals even when the components are shown on different drawings. Furthermore, in describing the embodiments of the present disclosure, detailed description associated with well-known functions or configurations has been omitted where it was determined that the detained description would unnecessarily obscure the gist of the present disclosure.

In describing elements of embodiments of the present disclosure, the terms first, second, A, B, (a), (b), and the like may be used herein. These terms are only used to distinguish one element from another element. The terms do not limit the corresponding elements irrespective of the nature, order, or priority of the elements. Furthermore, unless otherwise defined, all terms including technical and scientific terms used herein should be interpreted as is customary in the art to which the present disclosure pertains. It should be understood that terms used herein should be interpreted as including a meaning that is consistent with their meaning in the context of the present disclosure and the relevant art. The terms should not be interpreted in an idealized or overly formal sense unless expressly so defined herein.

When a component, device, element, or the like of the present disclosure is described as having a purpose or performing an operation, function, or the like, the component, device, or element should be considered herein as being “configured to” meet that purpose or perform that operation or function.

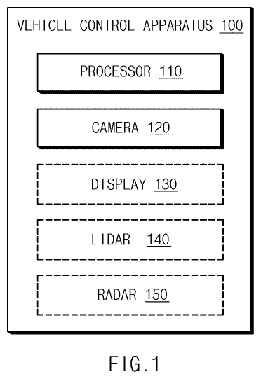

Hereinafter, various embodiments of the present disclosure are described in detail with reference to FIGS. 1-8.

FIG. 1 shows a block diagram of a vehicle control apparatus, according to an embodiment of the present disclosure.

Referring to FIG. 1, a vehicle control apparatus 100 according to an embodiment of the present disclosure may be implemented inside or outside a vehicle. For example, some of components included in the vehicle control apparatus 100 may be implemented inside or outside the vehicle. In an embodiment, the vehicle control apparatus 100 may be integrated with internal control units of a vehicle. For example, the vehicle control apparatus 100 may be implemented with a separate device so as to be coupled with control units of the vehicle by means of a separate connection means. In some examples, the vehicle control apparatus 100 may further include components not shown in FIG. 1.

Referring to FIG. 1, the vehicle control apparatus 100 according to an embodiment may include a processor 110 and a camera 120. According to an embodiment, the vehicle control apparatus 100 may further include at least one of a display 130, a Light Detection and Ranging (LiDAR) 140, a RADAR 150, or any combination thereof. The processor 110 or the camera 120 may be electrically and/or operably coupled with each other by an electronic component including a communication bus.

Herein, when pieces of hardware are described as being coupled operably, this may include a direct and/or indirect connection between the pieces of hardware established in a wired and/or wirelessly such that second hardware is controlled by first hardware among the pieces of hardware.

Although different blocks are shown in FIG. 1, the present disclosure is not limited thereto. Some of the pieces of hardware in FIG. 1 may be included in a single integrated circuit including a system on a chip (SoC). The type and/or number of hardware included in the vehicle control apparatus 100 is not limited to that shown in FIG. 1. For example, the vehicle control apparatus 100 may include only some of the pieces of hardware shown in FIG. 1.

The vehicle control apparatus 100 according to an embodiment may include hardware for processing data based on one or more instructions. The hardware for processing data may include the processor 110.

For example, the hardware for processing data may include an arithmetic and logic unit (ALU), a floating point unit (FPU), a field programmable gate array (FPGA), a central processing unit (CPU), and/or an application processor (AP). The processor 110 may include a structure of a single-core processor, or may include a structure of a multi-core processor including a dual core, a quad core, a hexa core, or an octa core.

The vehicle control apparatus 100 according to an embodiment may include a plurality of cameras. For example, the plurality of cameras may include the camera 120. The camera 120 may include one or more optical sensors (e.g., a charged coupled device (CCD) sensor and a complementary metal oxide semiconductor (CMOS) sensor) that generate electrical signals indicating the color and/or brightness of light. A plurality of optical sensors included in the camera 120 may be arranged in a form of a 2-dimensional array.

The plurality of cameras may obtain electrical signals from a plurality of optical sensors substantially simultaneously. The plurality of cameras may generate images or frames that correspond to light reaching the 2-dimensional array of optical sensors and which include a plurality of pixels arranged in two dimensions. Photo data captured by using the plurality of cameras may refer to a plurality of images obtained from the plurality of cameras. For example, video data captured by using the plurality of cameras may mean a sequence of a plurality of images obtained from the plurality of cameras at a specified frame rate.

The vehicle control apparatus 100 according to an embodiment may further include the display 130. In an example, the display 130 may provide a user with visualized information. The display 130 may be controlled by at least one of the processor 110, a graphic processing unit (GPU), or any combination thereof to output the visualized information to the user.

The display 130 may include at least one of a flat panel display (FPD), an electronic paper, or any combination thereof.

The FPD may include at least one of a liquid crystal display (LCD), a plasma display panel (PDP), a digital mirror device (DMD), one or more light emitting diodes (LEDs), a micro LED, a flexible display, or any combination thereof. The LED may include an organic LED (OLED). However, the present disclosure is not limited thereto.

The vehicle control apparatus 100 according to an embodiment may further include the LiDAR 140. In an example, the LiDAR 140 of the vehicle control apparatus 100 may obtain data sets obtained by identifying objects surrounding the vehicle control apparatus 100 (or a vehicle including the vehicle control apparatus 100). For example, the LiDAR 140 may identify at least one of a location of the surrounding object, a movement direction of the surrounding object, speed of the surrounding object, or any combination thereof based on a pulse laser signal emitted from the LiDAR 140 being reflected by the surrounding object and returned.

In an example, the LiDAR 140 may obtain data sets for expressing a surrounding external object in the space defined by an x-axis, a y-axis, and a z-axis based on a pulse laser signal reflected from surrounding objects. For example, the LiDAR 140 may obtain data sets including a plurality of points in the space, which is formed by the x-axis, the y-axis, and the z-axis, based on receiving the pulse laser signal at a specified period.

The vehicle control apparatus 100 according to an embodiment may further include the RADAR 150. In an example, the RADAR 150 may detect external objects by using electromagnetic (EM) scattering. For example, the RADAR 150 may identify at least one of a distance from the RADAR 150 to an external object, speed, a shape, or any combination thereof.

The RADAR 150 may generate RADAR plots corresponding to each of external objects, based on electromagnetic waves reflected from the external objects. The processor 110 may generate a RADAR track corresponding to a specific external object among the RADAR plots respectively corresponding to the external objects. For example, the RADAR track may include one of the RADAR plots to which an identifier for tracking an external object is assigned.

The processor 110 of the vehicle control apparatus 100 according to an embodiment may obtain first images through the plurality of cameras. For example, the processor 110 may obtain depth information indicating a distance between the vehicle and an external object included in each of the first images. As another example, the processor 110 may obtain semantic information indicating the type of the external object included in each of the first images. For example, the processor 110 may obtain the semantic information including data associated with the type of an external object included in each of the first images.

In an example, the plurality of cameras may be placed toward different directions, respectively. For example, a first camera among the plurality of cameras may be placed toward the front of the vehicle, to obtain images of the front of the vehicle. A second camera among the plurality of cameras may be placed toward the left side of the vehicle, to obtain images of the left side of the vehicle. A third camera among the plurality of cameras may be placed toward the right side of the vehicle, to obtain images of the right side of the vehicle. A fourth camera among the plurality of cameras may be placed toward the rear of the vehicle, to obtain images of the rear of the vehicle. However, the present disclosure is not limited to the above description.

In an embodiment, the processor 110 may generate sets of first space tensors respectively corresponding to the first images representing at least a portion within a specified radius from the vehicle based on at least one of the depth information, the semantic information, or any combination thereof included in each of the first images.

For example, a space tensor may be associated with one of pixels form an image. In an example, a first space tensor may be expressed in a format such as “(C, U, V, D, R, G, B)”.

In an example, ‘C’ in the first space tensor may be associated with the type of an external object. For example, the type of an external object may be identified by the semantic information.

In an example, each of ‘U’ and ‘V’ in the first space tensor may include a value indicating the location of the pixel corresponding to the space tensor. Each of ‘U’ and ‘V’ may, for example, include a location value of a pixel in the image. ‘D’ in the first space tensor may, for example, include a depth value associated with a distance between an external object and the vehicle. For example, the depth value associated with the distance between the external object and the vehicle may be identified by the depth information.

For example, in the first space tensor, ‘R’ may include an R value among red green blue (RGB) values of a pixel. In an example, in the first space tensor, ‘G’ may include a G value among the RGB values of a pixel. Further, in the first space tensor, ‘B’ may include a B value among the RGB values of a pixel. However, the present disclosure is not limited to the above description. For example, in the first space tensor, the value representing the color is expressed as an RGB value, but the present disclosure is not limited thereto. In various examples, the value expressing the color may include at least one of an RGB value, a hue saturation lightness (HSL) value, a hue saturation value (HSV) value, a hue saturation intensity (HSI) value, a cyan magenta yellow key (CMYK) value, or any combination thereof.

In an embodiment, the processor 110 may convert sets of first space tensors into sets of second space tensors expressed in a reference coordinate system. In an example, the reference coordinate system may include at least one of a vehicle coordinate system, a world coordinate system, a LiDAR coordinate system, or any combination thereof. For example, the reference coordinate system may include a coordinate system that represents space by a first axis, a second axis, and a third axis. For example, the first axis may include the x-axis. For example, the second axis may include the y-axis. For example, the third axis may include the z-axis. However, the present disclosure is not limited to the above description.

In an example, the second space tensor may be expressed in a format such as “(C, X, Y, Z, R, G, B)”.

For example, ‘C’ in the second space tensor may be associated with the type of an external object.

For example, in the second space tensor, ‘X’ may include an x coordinate of the reference coordinate system. In an example, in the second space tensor, ‘Y’ may include a y coordinate of the reference coordinate system. For example, in the second space tensor, ‘Z’ may include a z coordinate of the reference coordinate system. However, the present disclosure is not limited to the above description.

For example, in the second space tensor, ‘R’ may include an R value among the RGB values of a pixel. For example, in the second space tensor, ‘G’ may include a G value among the RGB values of a pixel. For example, in the second space tensor, ‘B’ may include a B value among the RGB values of a pixel. However, the present disclosure is not limited to the above description. For example, in the second space tensor, the value representing the color is expressed as an RGB value, but the present disclosure is not limited thereto.

In an embodiment, the processor 110 may convert sets of first space tensors into sets of second space tensors based on at least one of sets of first space tensors, internal parameters associated with a plurality of cameras, or any combination thereof. In an example, the internal parameters associated with a plurality of cameras may include a focal distance, a photoresistance coefficient, and/or camera distortion. However, the internal parameters associated with a plurality of cameras are not limited to the above description.

In an embodiment, the processor 110 may convert sets of first space tensors into sets of second space tensors based on Equation 1 below.

$$( D [ \begin{matrix}U \\ V \\ 1\end{matrix} ] {K}_{r}^{- 1} - t ) {R}^{- 1} = [ \begin{matrix}{X}^{′} \\ {Y}^{′} \\ {Z}^{′}\end{matrix} ] , ( C , U , V , D , R , G , B ) \to ( C , X , Y , Z , R , G , B ) \qquad [ Equation 1 ]$$

In Equation 1, C, U, V, D, R, G, and B may be obtained by the first space tensor. In Equation 1, Kᵣ⁻¹ may be associated with internal parameters of a plurality of cameras. In Equation 1, R⁻¹ may include a projection matrix.

As mentioned above, in an embodiment, the processor 110 may convert sets of first space tensors into sets of second space tensors expressed in a reference coordinate system by using Equation 1.

In an embodiment, the processor 110 may identify a reference image among the first images under a specified condition. The specified condition may be associated with a camera. For example, the specified condition may be associated with a direction in which the camera is facing. The processor 110 may set (or identify) an image obtained by a first camera facing the front of the vehicle among a plurality of cameras as the reference image.

In an example, the processor 110 may identify at least one object space tensor regarding the first specified type indicating a specified external object in each of the sets of second space tensors based on identifying the reference image according to the specified condition among the first images. For example, the first specified type may include a type representing an object indicating a straight line including a lane, a parking line, and/or a pillar.

In an embodiment, the processor 110 may correct the sets of second space tensors based on a set of reference space tensors included in the reference image, based on identifying the space tensor corresponding to the object space tensor in each of the sets of second space tensors. For example, the processor 110 may correct the sets of second space tensors such that the object space tensor included in the set of reference space tensors matches a space tensor with the first specified type in the set of second space tensors.

In an embodiment, the processor 110 may identify at least one background space tensor regarding the second specified type, that is different from the first specified type and that indicates a background, in each of the sets of second space tensors. In an example, the processor 110 may remove the background space tensor from each of the sets of second space tensors based on identifying at least one background space tensor regarding the second specified type, that is different from the first specified type and that indicates a background, in each of the sets of second space tensors. For example, the processor 110 may remove the background space tensor to perform calculations quickly.

The processor 110 may correct the sets of second space tensors based on the camera placed toward the front of the vehicle among a plurality of cameras.

In an embodiment, the processor 110 may generate sets of third space tensors by correcting the sets of second space tensors based on a set of reference space tensors included in the reference image based on identifying the space tensor corresponding to the object space tensor in each of the sets of second space tensors.

For example, the processor 110 may perform clustering on the sets of third space tensors. In an example, the third space tensor may be expressed in a format such as “(C, X, Y, Z, R, G, B, G)”. In the third space tensor, ‘C’, ‘X’, ‘Y’, ‘Z’, ‘R’, ‘G’, and ‘B’ may represent substantially the same thing as the second space tensor. In the third space tensor, ‘G’ may include a clustering index. For example, ‘G’ may include an identifier assigned based on clustering the sets of third space tensors.

In an embodiment, the processor 110 may output modeling information for expressing the first images in space based on applying a specified algorithm to the set of reference space tensors and the sets of third space tensors.

In an example, the specified algorithm may include a mesh generation algorithm. The mesh generation algorithm may include at least one of a ball rolling algorithm, a Delaunay triangulation, a marching cubes algorithm, a Voronoi diagram, a geometry-based mesh generation algorithm, a polygon mesh generation algorithm, or any combination thereof.

In an embodiment, the processor 110 may display the modeling information through the display 130. For example, the processor 110 may display, through the display 130, an image created as if viewed from above the vehicle, such as a bird-eye view.

In an embodiment, the processor 110 may obtain second images including the first images through the plurality of cameras at a plurality of time points including a time point at which the first images are obtained. The processor 110 may generate sets of first space tensors from each of the second images. The processor 110 may store second images obtained at the plurality of time points in a memory. The storing of the second images obtained at the plurality of time points in the memory may refer to accumulating the second images. In an example, outputting the modeling information by using the second images may include outputting the modeling information by integrating the second images obtained at the plurality of time points.

The plurality of time points may be expressed in units of second. As another example, the plurality of time points may be expressed in units of frame.

In an embodiment, the processor 110 may perform voxelization on the sets of second space tensors. For example, the processor 110 may perform clustering on the sets of second space tensors included in a specified duration based on performing voxelization on the sets of second space tensors. In an example, the processor 110 may assign identifiers to the clustered sets of second space tensors based on performing clustering on the sets of second space tensors.

In an embodiment, the processor 110 may identify i) a first portion of the sets of second space tensors at a first time point and ii) a second portion of the sets of second space tensors at a second time point.

For example, the processor 110 may calculate a mean space tensor change amount based on i) the first portion of the sets of second space tensors identified at the first time point and ii) the second portion of the sets of second space tensors identified at the second time point. The mean space tensor change amount may include a change amount of a value representing the color of the second portion corresponding to the first portion. For example, as described above, the value expressing the color may include an RGB value, a HSL value, a HSV value, a HSI value, and/or a CMYK value. However, the present disclosure is not limited to the above description.

The processor 110 may project a stationary object onto a reference coordinate system based on the mean space tensor change amount. For example, the processor 110 may express the modeling information by projecting the stationary object onto the reference coordinate system based on the mean space tensor change amount.

In an embodiment, the processor 110 may project the stationary object onto the reference coordinate system based on the mean space tensor change amount and a stationary object detection algorithm. In various examples, the stationary object detection algorithm may include at least one of a region of interest (ROI)-based algorithm, a difference frame algorithm, an optical flow-based algorithm, a histogram-based algorithm, an algorithm using a motion sensor, or any combination thereof.

In an embodiment, the processor 110 may identify a distance between an external object and the vehicle based on at least one of the LiDAR 140, or the RADAR 150, or any combination thereof. For example, the processor 110 may identify the distance between an external object and the vehicle based on sensor data obtained through at least one of the LiDAR 140, the RADAR 150, or any combination thereof. The processor 110 may apply the distance between the external object and the vehicle to at least one of the sets of first space tensors, the sets of second space tensors, the sets of third space tensors, or any combination thereof. The processor 110 may use a relatively accurate distance value by applying the distance between the external object and the vehicle, that is identified by the LiDAR 140 and/or the RADAR 150, to the sets of first space tensors, the sets of second space tensors, and/or the sets of third space tensors.

As mentioned above, the processor 110 of the vehicle control apparatus 100 according to an embodiment may accumulate and/or integrate images based on a space tensor, thereby relatively accurately expressing the surrounding environment of the vehicle. For example, the processor 110 may perform the operations described above when the vehicle is parked, thereby relatively accurately providing a user with the surrounding environment of the vehicle.

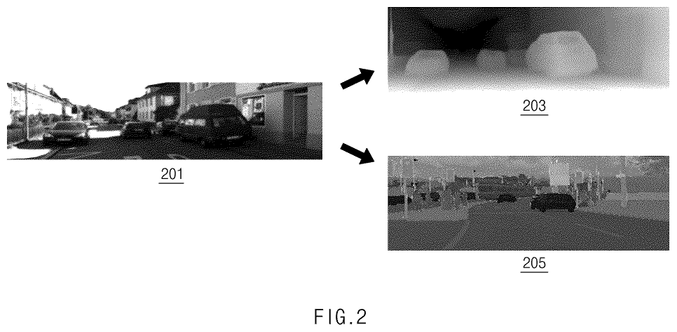

FIG. 2 shows an example of obtaining depth information and semantic information based on an image, according to an embodiment of the present disclosure.

Referring to FIG. 2, a processor (e.g., the processor 110 in FIG. 1) of a vehicle control apparatus (e.g., the vehicle control apparatus 100 of FIG. 1) according to an embodiment may obtain an image through a camera (e.g., the camera 120 in FIG. 1). For example, the image obtained through the camera may be expressed as in a first example 201.

In an embodiment, the processor may obtain first images through a plurality of cameras. In an example, the plurality of cameras may include cameras disposed facing different directions.

The processor may obtain depth information indicating a distance between a vehicle and an external object included in each of the first images, based on the first images obtained through the plurality of cameras. The depth information may be expressed as in a second example 203. The depth information may be represented by contrast. As another example, the depth information may be represented by color.

In an example, the processor may obtain semantic information including data associated with the type of the external object included in each of the first images based on the first images obtained through the plurality of cameras. The semantic information including data associated with the type of the external object may be expressed as illustrated in a third example 205. The semantic information may be expressed as a color corresponding to the type of the external object. As another example, the semantic information may be expressed as an identifier corresponding to the type of the external object.

According to an embodiment, the processor, through a recognizer, may obtain the depth information indicating the distance between the external object and the vehicle and/or the semantic information including data associated with the type of the external object. The recognizer may include a hardware component and/or software component for recognizing the external object for autonomous driving and/or driving assistance of the vehicle.

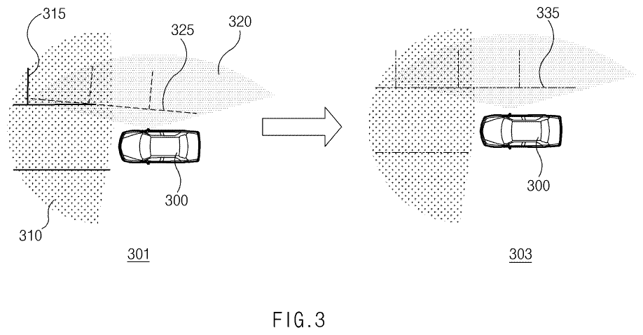

FIG. 3 shows an example of correcting an image or space tensor, according to an embodiment of the present disclosure.

Referring to FIG. 3, a processor (e.g., the processor 110 in FIG. 1) of a vehicle control apparatus (e.g., the vehicle control apparatus 100 of FIG. 1) according to an embodiment may obtain sets of first space tensors based on depth information and/or semantic information included in each of first images obtained through a plurality of cameras.

In an example, the processor may detect a parking line, a background, and/or an object by performing semantic segmentation and/or depth estimation. For example, the semantic segmentation may include an operation of segmenting an image in units of pixel and assigning meaning to an object and/or area corresponding to each pixel. For example, the depth estimation may include an operation of estimating the depth and/or distance of each pixel in an image. According to an embodiment, the processor may perform the depth estimation based on a neural network model stored in a memory.

In an embodiment, the processor may obtain sets of first space tensors based on performing the semantic segmentation and/or the depth estimation.

In an embodiment, the processor may identify at least one space tensor regarding the first specified type indicating a specified external object in the sets of first space tensors. For example, the specified external object may include an external object capable of expressing linearity including at least one of a parking line, a pillar, or any combination thereof.

Referring to a first example 301, in an embodiment, the processor may identify a first parking line 315 in an image obtained through a camera placed toward a front 310 of a vehicle 300. For example, the processor may identify the first parking line 315 based on a first set of first space tensors corresponding to the image obtained through the camera placed toward the front 310 of the vehicle 300.

The processor may identify a second parking line 325 in an image obtained through a camera placed toward a right side 320 of the vehicle 300. For example, the processor may identify the second parking line 325 based on a second set of first space tensors corresponding to the image obtained through the camera placed toward the right side 320 of the vehicle 300.

In an embodiment, the processor may identify an area commonly occupied by the first parking line 315 and the second parking line 325. In an embodiment, the processor may align the first parking line 315 and the second parking line 325 such that they at least partially overlap each other, based on identifying the first parking line 315 and the second parking line 325.

In an embodiment, the processor may align the first parking line 315 and the second parking line 325 such that they at least partially overlap each other, based on Equation 2 below.

$${W}_{2}^{′} 2 {W}_{1} = arg {min}_{{w}_{2}^{′} 2 {W}_{1}} \vert {l}_{1} - {W}_{2}^{′} 2 {W}_{1} {l}_{2} \vert , where {l}_{1} {l}_{2} in shared world \qquad [ Equation 2 ]$$

In Equation 2, W′₂ may include a coordinate system based on a camera placed toward the right side 320 of the vehicle 300. In Equation 2, W₁ may include a coordinate system based on a camera placed toward the front 310 of the vehicle 300. In Equation 2, ‘2’ may not mean number two, but may mean ‘to’. For example, W₂′2W₁ may refer to a matrix for correcting the first parking line 315 and the second parking line 325 such that they maximally overlap with other. In Equation 2, argmin_{w}_{₂}_{′2w}_{₁} may include an operation of obtaining the minimum value of W₂′2W₁. In Equation 2, l₁ may include a coordinate value representing the first parking line 315. In Equation 2, l₂ may include a coordinate value representing the second parking line 325.

The processor may correct the space tensors included in images corresponding to different directions based on the vehicle 300 by using Equation 2 described above.

Referring to a second example 303, in an embodiment, the processor may obtain a third parking line 335 that maximally overlaps the first parking line 315 and the second parking line 325 based on the vehicle 300 by correcting the second parking line 325 based on the first parking line 315. For example, the processor may obtain a space tensor corresponding to the third parking line 335, where the first parking line 315 and the second parking line 325 maximally overlap each other, by correcting the space tensor corresponding to the second parking line 325.

In an embodiment, the processor may correct the image obtained by a plurality of cameras by obtaining a space tensor corresponding to the third parking line 335. The processor may reduce distortion that occurs if images obtained by the plurality of cameras are combined, by performing the operations described above.

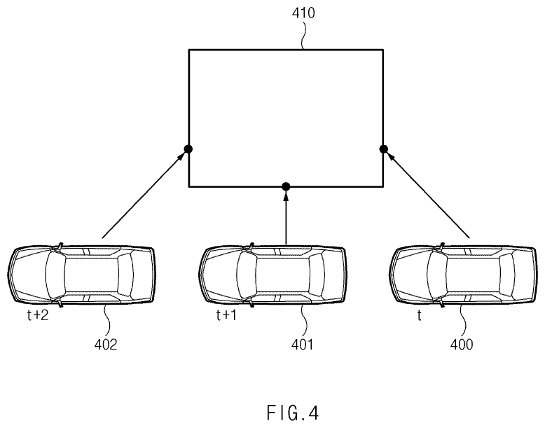

FIG. 4 shows an example of accumulating and integrating space tensors, according to an embodiment of the present disclosure.

Referring to FIG. 4, a processor (e.g., the processor 110 of FIG. 1) of a vehicle control apparatus (e.g., the vehicle control apparatus 100 of FIG. 1) according to an embodiment may accumulate and/or integrate space tensors.

In an embodiment, the processor may obtain images through a plurality of cameras at a plurality of time points t, t+1, and/or t+2. For example, the processor may obtain sets of space tensors from each of the images. The processor may accumulate (e.g., store) sets of space tensors obtained from images obtained at the plurality of time points.

In an example, the processor may obtain sets of space tensors while a vehicle is moving. For example, if the vehicle is located at a first location 400, the processor may obtain sets of space tensors corresponding to the rear of the external object 410. If the vehicle is located at a second location 401, the processor may obtain sets of space tensors corresponding to a side surface of the external object 410. If the vehicle is located at a third location 402, the processor may obtain sets of space tensors corresponding to a front surface of the external object 410.

The vehicle may be located at the first location 400 at the first time point t. The vehicle may be located at the second location 401 at the second time point t+1. Further, the vehicle may be located at the third location 402 at the third time point t+2.

In an example, at the first time point t, the processor may obtain sets of space tensors corresponding to a rear surface of the external object 410. At the second time point t+1, the processor may obtain sets of space tensors corresponding to the side surface of the external object 410. At the third time point t+2, the processor may obtain sets of space tensors corresponding to the front surface of the external object 410.

In an embodiment, the processor may accumulate sets of space tensors obtained at the first time point t, the second time point t+1, and the third time point t+2.

For example, the processor may perform clustering on space tensors, that are identified as being of the same type, based on a distance between the external object 410 and the vehicle. For example, the processor may perform clustering on sets of space tensors identified as being of the same type for accumulation. The processor may accumulate sets of space tensors based on performing clustering on sets of space tensors.

In an embodiment, the processor may perform clustering on sets of space tensors based on the external object identified as being in a stationary state. Because the accumulation is impossible if the external object is moving, the processor may perform clustering on sets of space tensors corresponding to an external object only if the external object is identified as being in a stationary state.

In an embodiment, the processor may perform voxelization on the sets of space tensors. For example, the processor may obtain a plurality of voxels by performing voxelization on the sets of space tensors. The processor may select the space tensor closest to the center of each of the voxels. For example, the processor may select the space tensor with the smallest square of (x, y, z). For example, the space tensor closest to the center of each of the voxels may be expressed as Vₜ.

In an embodiment, the processor may identify the movement of the vehicle from time point t−1 to time point t. The processor may obtain the change amount of the coordinate value included in the sets of space tensors from time point t−1 to time point t. In an embodiment, the processor may obtain R|T_{t-1-→t}. For example, as the vehicle moves from time point t−1 to time point t, R|T_{t-1-→t} may include a matrix for correcting the location of an external object.

For example, if the external object is a stationary object, the processor may output the same value even if R|T*Vₜ is performed at each of a plurality of time points.

In an embodiment, the processor may obtain a mean space tensor change amount within a specific cluster by calculating (Vₜ−R|t_{t-1→t}Vₜ₋₁)². For example, the processor may obtain a result value obtained by calculating a difference between a voxel at time point t and a voxel from compensating for a voxel at time point t−1 based on time point t. The processor may obtain the mean space tensor change amount within a specific cluster by calculating the square of the resulting value. Because the result value described above in the stationary object is the same at each time point, the processor may identify that the external object is a stationary object, by obtaining the result value.

As described above, the processor of the vehicle control apparatus according to an embodiment may relatively accurately identify that the external object is a stationary object, by performing the operations described above to identify that the external object is a stationary object.

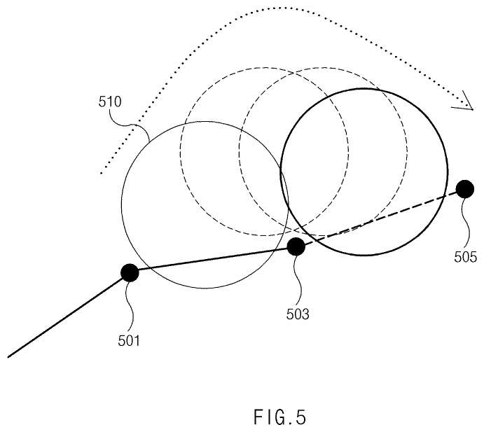

FIG. 5 shows an example of generating modeling information, according to an embodiment of the present disclosure.

Referring to FIG. 5, a processor (e.g., the processor 110 in FIG. 1) of a vehicle control apparatus (e.g., the vehicle control apparatus 100 in FIG. 1) according to an embodiment may obtain modeling information based on sets of space tensors. For example, the modeling information may include information for expressing images, obtained by a plurality of cameras, in a space formed by a first axis, a second axis, and a third axis.

For example, the processor may obtain sets of space tensors based on images obtained at a plurality of time points. The processor may obtain modeling information based on applying the specified algorithm to sets of space tensors. An example in FIG. 5 may include an example of explaining a ball rolling algorithm among specified algorithms.

For example, the processor may identify a first space tensor 501, a second space tensor 503, and a third space tensor 505. The processor may create a virtual ball 510. The processor may obtain a path, on which the virtual ball 510 moves, by rotating the virtual ball 510 based on the identified space tensors 501, 503, and 505. The processor may obtain modeling information based on the path on which the virtual ball 510 moves. For example, the processor may obtain the modeling information expressed in a mesh format based on the path on which the virtual ball 510 moves.

The processor may output (or display) the obtained modeling information through a display (e.g., the display 130 in FIG. 1).

As described above, the processor of the vehicle control apparatus according to an embodiment may provide a user with the surrounding environment of the vehicle and/or object information in 3D space by outputs (or displays) the obtained modeling information through the display.

According to an embodiment, the processor may transmit modeling information to an external electronic device (e.g., a mobile phone, a wearable device, and/or a tablet personal computer (PC)) owned by the user. The user may monitor the surrounding environment of the vehicle by receiving modeling information through an external electronic device owned by the user.

As described above, the processor of the vehicle control apparatus according to an embodiment may provide the user with the surrounding environment of the vehicle, thereby enhancing user experience.

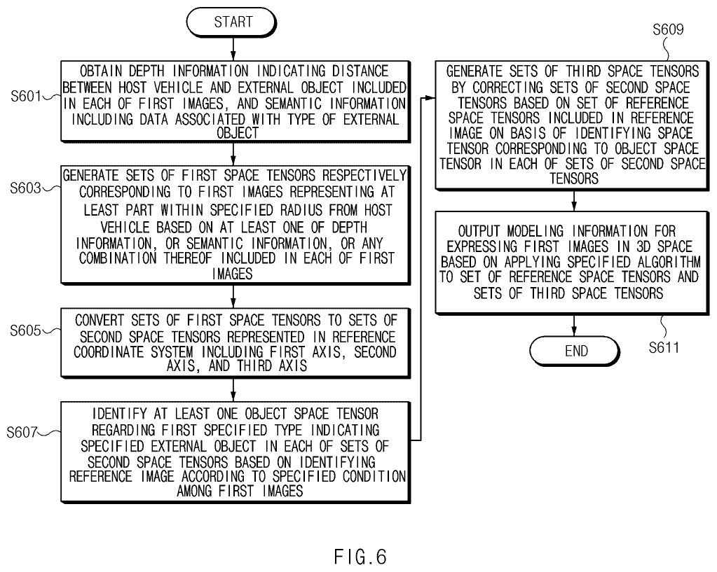

FIG. 6 shows a flowchart of a vehicle control method, according to an embodiment of the present disclosure.

Hereinafter, it is assumed that the vehicle control apparatus 100 of FIG. 1 performs the process of FIG. 6. In addition, in the description of FIG. 6, it should be understood that an operation described as being performed by an apparatus is controlled by the processor 110 of the vehicle control apparatus 100.

At least one of operations of FIG. 6 may be performed by the vehicle control apparatus 100 of FIG. 1. At least one of operations of FIG. 6 may be performed by the processor 110 of FIG. 1. The operations in FIG. 6 may be performed sequentially. However, the operations are not necessarily performed sequentially. For example, the order of operations may be changed and/or at least two operations may be performed in parallel.

Referring to FIG. 6, in an operation S601, depth information may be obtained indicating a distance between a vehicle and an external object included in each of first images. Additionally, semantic information may be obtained including data associated with a type of the external object.

In an operation S603, sets of first space tensors may be generated. The sets of first space tensors may respectively correspond to the first images representing at least a portion within a specified radius from the vehicle based on at least one of the depth information, the semantic information, or any combination thereof included in each of the first images.

The vehicle control method according to an embodiment may include an operation of obtaining second images including the first images through the plurality of cameras at a plurality of time points including a time point at which the first images are obtained. The vehicle control method according to an embodiment may include an operation of generating the sets of first space tensors in each of the second images.

In an operation S605, the sets of first space tensors nay be converted to sets of second space tensors represented in a reference coordinate system including a first axis, a second axis, and a third axis.

The vehicle control method according to an embodiment may include an operation of converting the sets of first space tensors into the sets of second space tensors based on at least one of the sets of first space tensors, internal parameters associated with the plurality of cameras, or any combination thereof.

In an operation S607, at least one object space tensor may be identified regarding a first specified type indicating a specified external object in each of the sets of second space tensors based on identifying a reference image according to a specified condition among the first images.

In an operation S609, sets of third space tensors may be generated by correcting the sets of second space tensors based on a set of reference space tensors included in the reference image based on identifying the space tensor corresponding to the object space tensor in each of the sets of second space tensors.

The vehicle control method according to an embodiment may include an operation of correcting the sets of second space tensors based on a camera placed toward a front of the vehicle among the plurality of cameras.

The vehicle control method according to an embodiment may include an operation of removing a background space tensor from each of the sets of second space tensors based on identifying the at least one background space tensor regarding a second specified type, that is different from the first specified type and which indicates a background, in each of the sets of second space tensors.

The vehicle control method according to an embodiment may include an operation of performing clustering on the sets of second space tensors included in a specified duration based on performing voxelization on the sets of second space tensors.

In an operation S611, modeling information may be output for expressing the first images in 3D space based on applying a specified algorithm to the set of reference space tensors and the sets of third space tensors.

The specified algorithm may include a mesh generation algorithm. In various examples, the mesh generation algorithm may include at least one of a ball rolling algorithm, a Delaunay triangulation, a marching cubes algorithm, a Voronoi diagram, a geometry-based mesh generation algorithm, a polygon mesh generation algorithm, or any combination thereof.

The vehicle control method according to an embodiment may include an operation of calculating a mean space tensor change amount based on i) the first portion of the sets of second space tensors identified at the first time point and ii) the second portion of the sets of second space tensors identified at the second time point. The vehicle control method according to an embodiment may include an operation of representing the modeling information by projecting the stationary object onto the reference coordinate system based on the mean space tensor change amount. For example, the mean space tensor change amount may include a change amount of a value representing the color of the second portion corresponding to the first portion.

The vehicle control method according to an embodiment may further include projecting the stationary object onto the reference coordinate system based on the mean space tensor change amount and a stationary object detection algorithm. For example, the vehicle control method may include an operation of identifying a stationary object based on a stationary object detection algorithm.

For example, the stationary object detection algorithm may include at least one of an ROI-based algorithm, a difference frame algorithm, an optical flow-based algorithm, a histogram-based algorithm, an algorithm using a motion sensor, or any combination thereof.

The vehicle control method according to an embodiment may include an operation of identifying a distance between an external object and the vehicle based on at least one of the LiDAR, the RADAR, or any combination thereof. The vehicle control method according to an embodiment may include an operation of applying the distance between the external object and the vehicle to at least one of the sets of first space tensors, the sets of second space tensors, or the sets of third space tensors, or any combination thereof.

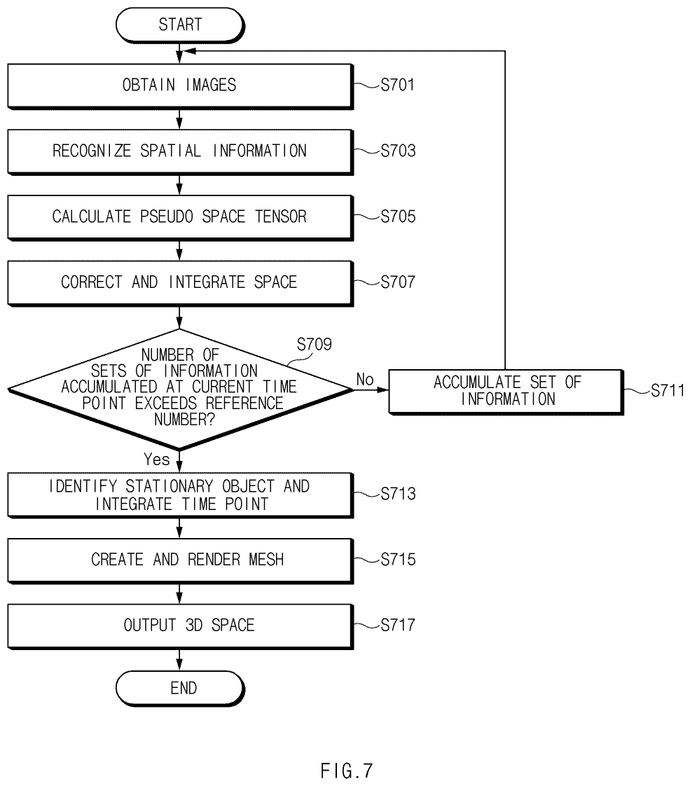

FIG. 7 shows a flowchart of a vehicle control method, according to an embodiment of the present disclosure.

Hereinafter, it is assumed that the vehicle control apparatus 100 of FIG. 1 performs the process of FIG. 7. In addition, in the description of FIG. 7, it should be understood that an operation described as being performed by an apparatus is controlled by the processor 110 of the vehicle control apparatus 100.

At least one of operations of FIG. 7 may be performed by the vehicle control apparatus 100 of FIG. 1. At least one of operations of FIG. 7 may be performed by the processor 110 of FIG. 1. The operations in FIG. 7 may be performed sequentially, but the operations are not necessarily performed sequentially. For example, the order of operations may be changed and/or at least two operations may be performed in parallel.

Referring to FIG. 7, in an operation S701, images may be obtained. For example, the images may be obtained through a plurality of cameras arranged in various directions.

In an operation S703, spatial information may be recognized. For example, depth information and/or semantic information may be obtained from each of the images. For example, the spatial information may include the depth information and/or the semantic information.

In an operation S705, a pseudo space tensor may be calculated. For example, the pseudo space tensor may be calculated based on recognizing the spatial information. For example, the pseudo space tensor associated with an external object (or a stationary object) may be extracted based on recognizing the spatial information.

In an operation S707, space may be correlated and integrated. For example, the extracted pseudo space tensor may be integrated based on the semantic information and/or linearity. For example, the linearity may include properties of an external object expressed in a form of line segments, such as parking lines and/or pillars.

In an operation S709, it may be determined whether the number of sets of information accumulated at a current time point exceeds a reference number. For example, the number of sets of information accumulated at the current time point may include the number of sets of information created by correcting and integrating space based on the obtained images.

If the number of sets of information accumulated at the current time point does not exceed the reference number (No in the operation S709), a set of information may be accumulated in an operation S711. For example, the vehicle control method may include an accumulation operation by returning to S701 and obtaining sets of information.

If the number of sets of information accumulated at the current time point exceeds the reference number (Yes in the operation S709), a stationary object be identified and a time point may be integrated.

For example, the vehicle control method may include an operation of identifying a stationary object included in images based on the pseudo space tensor. The vehicle control method may include an operation of integrating images obtained from a plurality of time points and compensating for the current time point.

In an operation S715, a mesh may be created and rendered. For example, the vehicle control method may include an operation of creating and/or rendering the mesh based on a specified algorithm.

In an operation S717, 3D space may be output. The vehicle control method may include an operation of outputting the 3D space based on creating and rendering the mesh. For example, the vehicle control method may include an operation of obtaining modeling information based on creating and rendering the mesh. For example, the vehicle control method may include an operation of displaying the obtained modeling information through a display.

As described above, the vehicle control method according to an embodiment may include an operation of identifying a stationary object within images and integrating the images based on the identified stationary object. The vehicle control method may perform the operations described above at a plurality of time points, thereby relatively accurately representing the surrounding environment of the vehicle in the 3D space. The vehicle control method may provide a user with relatively accurate information while the vehicle is parking, by relatively accurately expressing the surrounding environment of the vehicle in the 3D space.

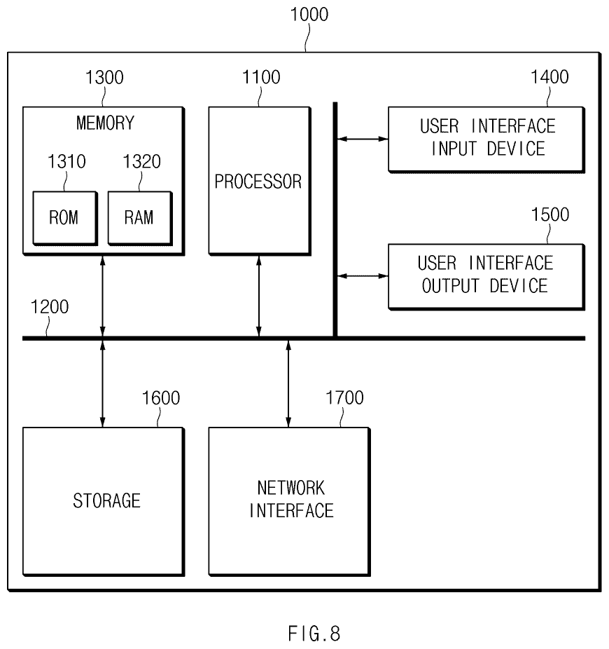

FIG. 8 shows a computing system associated with a vehicle control apparatus or vehicle control method, according to an embodiment of the present disclosure.

Referring to FIG. 8, a computing system 1000 may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read only memory (ROM) and a random access memory (RAM).

Accordingly, the operations of the method or algorithm described in connection with the embodiments disclosed in the specification may be directly implemented with a hardware module, a software module, or a combination of the hardware module and the software module, which is executed by the processor 1100. The software module may reside on a storage medium (i.e., the memory 1300 and/or the storage 1600) such as a random access memory (RAM), a flash memory, a read only memory (ROM), an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

The above description is merely an example of the technical idea of the present disclosure, and various modifications and alterations may be made by one having ordinary skill in the art without departing from the essential characteristic of the present disclosure.

Accordingly, embodiments of the present disclosure are intended not to limit but to explain the technical idea of the present disclosure, and the scope and spirit of the present disclosure is not limited by the above embodiments. The scope of protection of the present disclosure should be construed by the attached claims, and all equivalents thereof should be construed as being included within the scope of the present disclosure.

Embodiment of the present disclosure may accurately project and provide a surrounding environment of a vehicle in 3D space.

Moreover, embodiments of the present disclosure may improve stability in parking situations by accurately identifying and providing a distance between the vehicle and an external object.

Furthermore, embodiments of the present disclosure may enhance user experience by accurately providing a user with the surrounding environment of the vehicle.

Moreover, a variety of effects directly or indirectly understood through the present disclosure may be provided.

Hereinabove, although the present disclosure has been described with reference to certain embodiments and the accompanying drawings, the present disclosure is not limited thereto. Rather, the present disclosure may be variously modified and altered by those having ordinary skill in the art to which the present disclosure pertains without departing from the spirit and scope of the present disclosure claimed in the following claims.

What is claimed is:

1. A vehicle control apparatus comprising:
a plurality of cameras; and
a processor configured to, based on first images obtained through the plurality of cameras
obtain i) depth information indicating a distance between a vehicle and an external object included in each of the first images and ii) semantic information including data associated with a type of the external object,
generate sets of first space tensors respectively corresponding to the first images representing at least a portion within a specified radius from the vehicle based on at least one of the depth information, the semantic information, or any combination thereof, that is included in each of the first images,
convert the sets of first space tensors to sets of second space tensors represented in a reference coordinate system including a first axis, a second axis, and a third axis,
identify at least one object space tensor regarding a first specified type indicating a specified external object in each of the sets of second space tensors based on identifying a reference image according to a specified condition among the first images,
generate sets of third space tensors by correcting the sets of second space tensors based on a set of reference space tensors included in the reference image, based on identifying a space tensor corresponding to the object space tensor in each of the sets of second space tensors, and
output modeling information representing the first images in 3D space, based on applying a specified algorithm to the set of reference space tensors and the sets of third space tensors.

2. The vehicle control apparatus of claim 1, wherein the processor is configured to:
obtain second images including the first images through the plurality of cameras at a plurality of time points including a time point at which the first images are obtained; and
generate the sets of first space tensors in each of the second images.

3. The vehicle control apparatus of claim 1, wherein the processor is configured to correct the sets of second space tensors based on a camera placed toward a front of the vehicle among the plurality of cameras.

4. The vehicle control apparatus of claim 1, wherein the processor is configured to remove a background space tensor from each of the sets of second space tensors based on identifying at least one background space tensor regarding a second specified type, that is different from the first specified type and that indicates a background, in each of the sets of second space tensors.

5. The vehicle control apparatus of claim 1, wherein the processor is configured to perform clustering on the sets of second space tensors included in a specified duration based on performing voxelization on the sets of second space tensors.

6. The vehicle control apparatus of claim 1, wherein the processor is configured to convert the sets of first space tensors into the sets of second space tensors based on at least one of the sets of first space tensors, internal parameters associated with the plurality of cameras, or any combination thereof.

7. The vehicle control apparatus of claim 1, wherein the processor is configured to:
calculate a mean space tensor change amount based on i) a first portion of the sets of second space tensors identified at a first time point and ii) a second portion of the sets of second space tensors identified at a second time point; and
represent the modeling information by projecting a stationary object onto the reference coordinate system based on the mean space tensor change amount,
wherein the mean space tensor change amount includes a change amount of a value representing a color of the second portion corresponding to the first portion.

8. The vehicle control apparatus of claim 7, wherein the processor is configured to project the stationary object onto the reference coordinate system based on the mean space tensor change amount and a stationary object detection algorithm.

9. The vehicle control apparatus of claim 8, wherein the stationary object detection algorithm includes at least one of a region of interest (ROI)-based algorithm, a difference frame algorithm, an optical flow-based algorithm, a histogram-based algorithm, an algorithm using a motion sensor, or any combination thereof.

10. The vehicle control apparatus of claim 1, further comprising:
at least one of a Light Detection and Ranging (LiDAR), a RADAR, or any combination thereof,
wherein the processor is configured to
identify a distance between the external object and the vehicle based on at least one of the LiDAR, the RADAR, or any combination thereof, and
apply the distance between the external object and the vehicle to at least one of the sets of first space tensors, the sets of second space tensors, the sets of third space tensors, or any combination thereof.

11. The vehicle control apparatus of claim 1, wherein the specified algorithm includes a mesh generation algorithm, and wherein the mesh generation algorithm includes at least one of a ball rolling algorithm, a Delaunay triangulation, a marching cubes algorithm, a Voronoi diagram, a geometry-based mesh generation algorithm, a polygon mesh generation algorithm, or any combination thereof.

12. A vehicle control method, the method comprising:
obtaining, by a processor, i) depth information indicating a distance between a vehicle and an external object included in each of first images obtained through a plurality of cameras and ii) semantic information including data associated with a type of the external object;
generating, by the processor, sets of first space tensors respectively corresponding to the first images representing at least a portion within a specified radius from the vehicle based on at least one of the depth information, the semantic information, or any combination thereof, that is included in each of the first images;
converting, by the processor, the sets of first space tensors to sets of second space tensors represented in a reference coordinate system including a first axis, a second axis, and a third axis;
identifying, by the processor, at least one object space tensor regarding a first specified type indicating a specified external object in each of the sets of second space tensors based on identifying a reference image according to a specified condition among the first images;
generating, by the processor, sets of third space tensors by correcting the sets of second space tensors based on a set of reference space tensors included in the reference image, based on identifying a space tensor corresponding to the object space tensor in each of the sets of second space tensors; and
outputting, by the processor, modeling information representing the first images in 3D space, based on applying a specified algorithm to the set of reference space tensors and the sets of third space tensors.

13. The method of claim 12, further comprising:
obtaining, by the processor, second images including the first images through the plurality of cameras at a plurality of time points including a time point at which the first images are obtained; and
generating, by the processor, the sets of first space tensors in each of the second images.

14. The method of claim 12, further comprising correcting, by the processor, the sets of second space tensors based on a camera placed toward a front of the vehicle among the plurality of cameras.

15. The method of claim 12, further comprising removing, by the processor, a background space tensor from each of the sets of second space tensors based on identifying at least one background space tensor regarding a second specified type, which is different from the first specified type and which indicates a background, in each of the sets of second space tensors.

16. The method of claim 12, further comprising performing, by the processor, clustering on the sets of second space tensors included in a specified duration based on performing voxelization on the sets of second space tensors.

17. The method of claim 12, further comprising converting, by the processor, the sets of first space tensors into the sets of second space tensors based on at least one of the sets of first space tensors, internal parameters associated with the plurality of cameras, or any combination thereof.

18. The method of claim 12, further comprising:
calculating, by the processor, a mean space tensor change amount based on a first portion of the sets of second space tensors identified at a first time point, and a second portion of the sets of second space tensors identified at a second time point; and
representing, by the processor, the modeling information by projecting a stationary object onto the reference coordinate system based on the mean space tensor change amount,
wherein the mean space tensor change amount includes a change amount of a value representing a color of the second portion corresponding to the first portion.

19. The method of claim 18, further comprising projecting, by the processor, the stationary object onto the reference coordinate system based on the mean space tensor change amount and a stationary object detection algorithm.

20. The method of claim 19, wherein the stationary object detection algorithm includes at least one of an ROI-based algorithm, a difference frame algorithm, an optical flow-based algorithm, a histogram-based algorithm, an algorithm using a motion sensor, or any combination thereof.
